(19) United States
(12) Patent Application Publication
(10) Pub. No.: US 2023/0047298 A1
(43) Pub. Date: Feb. 16, 2023

(54) Flash Cards for Memory Exercise use

(71) Applicants: Mary Sadlon Boyer, Lewes, DE (US); Sandra Sadlon Hrin, Lewes, DE (US)

(72) Inventors: Mary Sadlon Boyer, Lewes, DE (US); Sandra Sadlon Hrin, Lewes, DE (US)

(21) Appl. No.: 17/301,438

(22) Filed: Aug. 16, 2021

(51) Int. Cl. G09B 19/00

(52) U.S. Cl. CPC G09B 19/00

(57) ABSTRACT

Deck of Flash Cards containing the picture of common objects to be used for patients with memory loss.

Deck of Flash Cards containing pictures of objects familiar to a child to be used for children to increase their vocabulary.

NOTE: Since there are thousands of models of computers, smart phones, digital cameras and printers, instructions cannot be provided for the interface between these devices. An individual must follow the manufacturer's instructions for the devices purchased.

A. Buy Supplies-Buy
1) standard card stock paper in manila or white color,
2) a paper cutter, or scissors
3) color printer,
4) computer,
5) smart phone or digital camera,
6) USB cable compatible with your computer and camera.

B. Connect your computer to your printer—Follow manufacturer's directions.

C. Take and Save Pictures
1) For mild memory loss patients-
   Use a digital camera or smart phone to take pictures (following manufacturer's directions) of common household items such as a Plate, Fork, Spoon, Knife, Toaster, Coffee Pot, Dress, Shoes, window, door, car, etc. Connect digital camera or smart phone to your computer following the manufacturer's directions. Save each picture onto your computer, following manufacturer's directions.
2) For children-
   Use a digital camera or smart phone to take pictures (following manufacturer's directions) of objects that will enlarge a child's vocabulary such as a cat, dog, desk pencil, chair, table, glass of milk, shoes, hat, mittens, scarf, computer, school bus, truck, etc. Connect digital camera or smart phone to your computer following the manufacturer's directions. Save each picture onto your computer, following manufacturer's directions.

D. Determine the size of the individual card you want to produce. You could choose to use a rectangle or square, from 2.5″×3.5″ up to 5″×5″. Insert card stock in paper feeder of printer. You can print one picture per page or multiple pictures per page if you determine the correct spacing of each picture. Print your pictures.

E. Type or write title of picture on the back of picture

F. Cut Pictures according to the size you want

G. Assemble 52 cards into one deck of cards. The deck is ready to use

### CONCLUSION

For mild memory loss patients—When a person with mild memory loss uses this deck of cards on a regular basis, it will help them remember everyday objects for a longer period of time than they would have without the mental exercise. OR A person with mild memory loss will remember the everyday objects on the cards longer then they would have without the exercise.

For children—Identifying the object on the card helps the child recognize common objects increasing their vocabulary. Turning the card over gives the child the spelling of the object.

### DESCRIPTION

Purpose—Deck of Flash cards to be used for patients with memory loss to help them remember objects longer, or for children to increase their vocabulary.

Size—Between standard playing card size of 2.5″×3.5″ and 5″×5″ size.

Content—cards will contain pictures of items in a person's life in categories such as furniture, appliances, clothing, jewelry, utensils, other household items, plants, animals, vehicles and structures with which a person is familiar. The basic deck of cards will contain examples from all categories. Additional decks will contain pictures from specific categories such as “The Outdoors”, “In The Home”, “Dressing and Grooming”, plus the potential for others.

Additional decks of cards will contain commonly used words to assist with word retention. In the case of cards used for children, to increase vocabulary and visual recognition of common objects, animals, colors, numbers, etc.

Pictures will be in black & white and color.

All pictures will be original images taken by Mary Boyer or Sandra Hrin and copyrighted under this application.

The name of the picture will appear on the back of each card.

Marketing—Decks will be sold to organizations and individuals that care for memory loss patients such as rehab facilities, hospitals, and memory care units.

For use by children, decks will be sold to schools and individuals.

1. For mild memory loss patients—When a person with mild memory loss uses this deck of cards on a regular basis, it will help them remember everyday objects for a longer period of time than they would have without the mental and visual use of the cards.

2. For children—Identifying the object on the card helps the child recognize common objects increasing their vocabulary. Turning the card over gives the child the spelling of the object which he/she can practice spelling.
